(19) United States
(12) Patent Application Publication
(10) Pub. No.: US 2020/0068076 A1
(43) Pub. Date: Feb. 27, 2020

(54) FAILING COMPONENT IDENTIFICATION WITH ULTRASONIC MICROPHONE

(71) Applicant: Hewlett-Packard Development Company, L.P., Spring, TX (US)

(72) Inventor: Duane A Koehler, Vancouver, WA (US)

(21) Appl. No.: 16/493,020

(22) PCT Filed: Mar. 17, 2017
(86) PCT No.: PCT/US2017/022951

§ 371 Date: Sep. 11, 2019

(51) Int. Cl. H04N 1/00; H04R 1/40; H04R 3/00; G10L 25/51; B41J 29/393

(52) U.S. Cl. CPC H04N 1/00034; H04R 1/406; H04R 3/005; H04R 2201/401; H04N 1/00037; B41J 29/393; G10L 25/51

(57) ABSTRACT

In one example in accordance with the present disclosure, a method of identifying failing components using an ultrasonic microphone is described. According to the method, an ultrasonic audio signal generated during operation of a device is received at an ultrasonic microphone disposed within the device. The received ultrasonic audio signal is compared against a baseline ultrasonic audio signal for the device to detect deviations between the received ultrasonic audio signal and the baseline ultrasonic audio signal. Based on detected deviations between the received ultrasonic audio signal and the baseline ultrasonic audio signal being greater than a threshold amount, a failing component within the device is identified.

### BACKGROUND

Mechanical devices such as printers, fax machines, copy machines, and the like are regularly used in home, office, and other applications. Such devices include mechanical components. The mechanical components in these devices, like mechanical components in any device, deteriorate over time such that their functionality is affected, which may affect the overall functionality of the device in which they are installed.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a flowchart of a method for identifying a failing component using an ultrasonic microphone, according to an example of the principles described herein.

FIG. 2 is a block diagram of a printing system for identifying a failing component using an ultrasonic microphone, according to an example of the principles described herein.

FIG. 3 is an illustration of a comparison between a received ultrasonic audio signal and a baseline ultrasonic audio signal, according to an example of the principles described herein.

FIG. 4 is another flowchart of a method for identifying a failing component using an ultrasonic microphone, according to another example of the principles described herein.

FIG. 5 is a diagram of a computing system to identifying a failing component using an ultrasonic microphone, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Mechanical devices such as printers, fax machines, copy machines, and the like are regularly used in home, office, and other applications. Such devices include mechanical components. The mechanical components in these devices, like mechanical components in any device, deteriorate over time such that their functionality is affected, which may affect the overall functionality of the device in which they are installed.

Examples of such devices are fluid ejection devices such as two-dimensional printers that incorporate an inkjet printhead, multi-function printers (MFPs), and additive manufacturing apparatuses. These devices are widely used for precisely, and rapidly, dispensing small quantities of fluid. For example, some fluid ejection devices may dispense functional agents in an additive manufacturing process. Other fluid ejection devices may dispense ink on a two-dimensional print medium such as paper. In other words, the systems and methods described herein may be implemented in a two-dimensional printing, i.e., depositing fluid on a substrate, and in three-dimensional printing, i.e., depositing a fusing agent or other functional agent on a powder base to form a three-dimensional printed product.

The fluid ejection devices sequentially eject fluid to cause characters, symbols, and/or other patterns to be formed on the surface. The surface may be a layer of build material or other three-dimensional surface in an additive manufacturing apparatus. In other examples, the surface is a medium such as paper in an inkjet printer for two-dimensional printing. In operation, fluid flows from a reservoir to the fluid ejection device. To create the characters, symbols, and/or other pattern, a printer, additive manufacturing apparatus, multi-jet fusion device, MFP device, or other component in which the fluid ejection device is installed sends electrical signals to the fluid ejection device via electrical bond pads on the fluid ejection device. The fluid ejection device then ejects a small droplet of fluid from the reservoir onto the surface. These droplets combine to form an image or other pattern on the surface.

To eject the fluid, these devices include nozzles. A nozzle includes an ejector, a firing chamber, and a nozzle orifice. The nozzle orifice allows fluid, such as ink or a fusing agent, to be deposited onto a surface, such as a powder build material or a print medium such as paper. The firing chamber includes a small amount of fluid. The ejector is a mechanism for ejecting fluid through the nozzle orifice from a firing chamber. The ejector may include a thermal resistor or other thermal device, a piezoelectric element, or other mechanism for ejecting fluid from the firing chamber.

For example, the ejector may be a thermal resistor. As the thermal resistor heats up in response to an applied energy, such as a supplied voltage pulse. As the thermal resistor heats up, a portion of the fluid in the firing chamber vaporizes to form a bubble. This bubble pushes fluid out the nozzle orifice and onto the surface. As the vaporized fluid bubble pops, a negative pressure within the firing chamber draws fluid into the firing chamber from the fluid supply, and the process repeats. This system is referred to as a thermal inkjet system.

In another example, the ejector may be a piezoelectric device. As a voltage is applied, the piezoelectric device changes shape which generates a pressure pulse in the firing chamber that pushes a fluid out the nozzle orifice and onto the surface.

While such mechanical devices, and specifically fluid ejection devices, undoubtedly have advanced the field of precise fluid delivery, some conditions impact their effectiveness. For example, fluid ejection devices in whatever form include multiple mechanical parts. As with all mechanical parts, the components deteriorate over time and may even break down completely. The wearing down of these components is inevitable and interrupts the technical performance of a device in which they are installed. In some cases, if a component fails entirely, it can completely halt operations within the device. For example, in a printing device, a pick roller moves paper from an input tray into a print path to receive a printing fluid. However, if the pick roller becomes inoperable, no paper is moved into the printing path, and printing is not possible until the pick roller is replaced or repaired, which could be a significant amount of time.

Accordingly, the present specification is directed to identifying failing components before they fail, such that they can be replaced before they completely inhibit printing performance. As components begin to fail, they perform differently. For example, a pick roller may vibrate more as it ages. This difference in performance can be detected as an audio signal. Accordingly, the present specification describes using an ultrasonic microphone to pick up ultrasonic audio signals that are generated during the operation of a device. That is, as devices begin to fail, they may vibrate or move differently, which differences create vibrations, which can be acquired as an ultrasonic audio signal. This ultrasonic audio signal can be compared to a baseline ultrasonic audio signal. The baseline ultrasonic audio signal is an ultrasonic audio signal that corresponds to a device that is operating as expected. Accordingly, any deviations between the received ultrasonic audio signal and the baseline ultrasonic audio signal would thereby indicate a potential failing, failed, or faulty component. Accordingly, the received ultrasonic audio signal can be compared to this baseline ultrasonic audio signal to identify any such discrepancies. Once a discrepancy is identified, the failing of faulty component that is the origin of the discrepancy can be identified. Using an ultrasonic microphone allows for a failing component to be detected before it becomes audible, and thus a nuisance due to undesirable noises in the audible range.

In some examples, the baseline ultrasonic audio signal is formed by data collected from many devices. That is, a group of printing devices can be connected to a central server. Ultrasonic audio signals can be collected from these printing devices either to improve the baseline ultrasonic audio signal or to account for the detection of new failure modes.

Specifically, the present application describes a method. According to the method, an ultrasonic audio signal generated during the operation of a device is received at an ultrasonic microphone disposed within the device. The received ultrasonic audio signal is compared against a baseline ultrasonic audio signal for the device to detect deviations between the received ultrasonic audio signal and the baseline ultrasonic audio signal. Based on detected deviations between the received ultrasonic audio signal and the baseline ultrasonic audio signal being greater than a threshold amount, a failing component of the device is identified.

The present specification also describes a printing system. Within the printing system, a printing device forms printed marks on a medium by depositing a printing compound on the medium. At least one ultrasonic microphone of the system, which ultrasonic microphone is disposed within the printing device, receives an ultrasonic audio signal generated during the operation of the printing device. The printing system also includes a database that includes a number of baseline ultrasonic audio signals for the printing device. A controller of the system 1) compares the received ultrasonic audio signal against a baseline ultrasonic audio signal for the printing device and 2) based on detected deviations between the received ultrasonic audio signal and the baseline ultrasonic audio signal for the printing device; identifies a failing component within the printing device.

The present specification also describes a computing system that includes a processor and a machine-readable storage medium coupled to the processor. The computing system also includes an instruction set stored in the machine-readable storage medium to be executed by the processor. The instruction set includes instructions to receive, at an ultrasonic microphone disposed in a printing device, an ultrasonic audio signal generated during the operation of the printing device. The instruction set also includes instructions to convert the received ultrasonic audio signal from a time domain representation into a frequency domain representation and instructions to compare a frequency domain representation of the received ultrasonic audio signal against a frequency domain representation of a baseline ultrasonic audio signal for the printing device. The instruction set further includes instructions to identify deviations between the frequency domain representation of the received ultrasonic audio signal and the frequency domain representation of the baseline ultrasonic audio signal. These deviations include deviations in amplitude, frequency, or combinations thereof. The instruction set also includes instructions to, based on characteristics of the identified deviations between the received ultrasonic audio signal and the baseline ultrasonic audio signal for the printing device being greater than a threshold amount, identify a failing component within the printing device and instructions to, and provide a notification of the failing component within the printing device.

In one example, using such a method 1) allows for early detection of failing, failed, or faulty components; 2) provides a detection method that does not rely on encryption of audio signals; and 3) is updateable based on collected operating information. However, it is contemplated that the devices disclosed herein may address other matters and deficiencies in a number of technical areas.

As used in the present specification and in the appended claims, the term “nozzle” refers to an individual component of a fluid ejection device that dispenses fluid onto a surface. The nozzle includes at least a firing chamber, an ejector, and a shared nozzle orifice.

Further, as used in the present specification and in the appended claims, the term “ultrasonic” refers to frequencies that are above the audible range. For example, ultrasonic audio signals may be those audio signals above 20 kilohertz (kHz).

Even further, as used in the present specification and in the appended claims, the term “a number of” or similar language is meant to be understood broadly as any positive number including 1 to infinity.

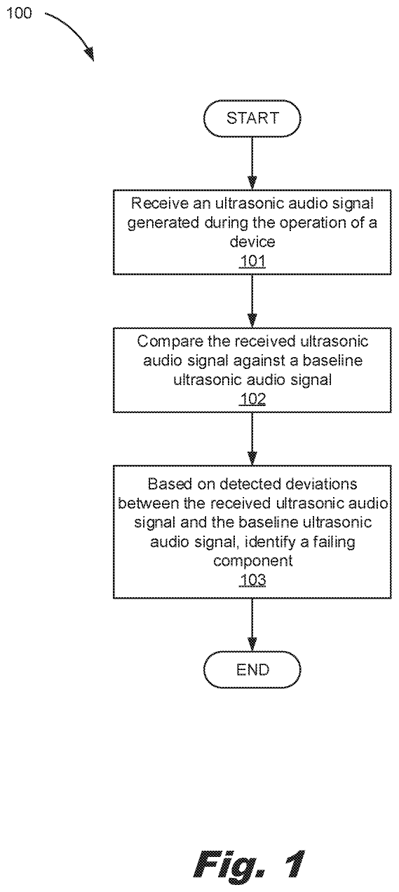

FIG. 1 is a flowchart of a method (100) for identifying a failing component using an ultrasonic microphone, according to an example of the principles described herein. An ultrasonic audio signal is generated during the operation of a device. An ultrasonic audio signal refers to an audio signal that is made up of frequencies that are above those detectable by the human ear. For example, ultrasonic frequencies may include frequencies greater than 20 Kilohertz (kHz).

This ultrasonic audio signal is received (block 101) by an ultrasonic microphone disposed in the device. The ultrasonic microphone may refer to any device that can pick up audio signals in an ultrasonic audio range. For example, a human may hear audio signals with frequencies less than 20 kHz. Accordingly, the ultrasonic microphone may pick up audio signals that have frequencies greater than this amount, which audio signals may be referred to as ultrasonic audio signals. Such ultrasonic audio signals may be generated during the operation of a device. Take for example, a case where the device is a printing device that operates to drop a printing fluid or toner onto a medium to form images and/or text. During operation, components within the printing device move, which movement generates audio signatures that can be picked up by the ultrasonic microphone. Over time, as the components deteriorate or begin to malfunction, they operate differently, which affects the vibrations and noises generated therefrom. These differences can be picked up as differences in the ultrasonic audio signal. Eventually the differences in an audio signal of a properly functioning component and a malfunctioning component can be detected by a human ear. However, smaller changes, which may indicate a component is just beginning to fail, may not generate differences that are distinguishable to a human ear. An ultrasonic microphone can be designed and integrated in such a way as to be sensitive enough to pick up these small changes and therefore provides an early detection system for faulty, failing, or failed components.

Moreover, implementing an ultrasonic microphone, as opposed to a standard microphone, avoids privacy concerns. For example, a printing device may be located in an office space, where conversations may take place near the printing device in which the microphone is located. A microphone in such a printing device, in addition to capturing audible audio signals generated by the device, may capture other audible audio signals such as conversations, which could lead to concerns regarding security and/or privacy. Accordingly, the ultrasonic microphone of the present system may be tuned to capture ultrasonic audio signals, and not to capture audio signals within the range of human hearing. Thus, the present method avoids the security and/or privacy issues associated with implementing a standard microphone.

The received ultrasonic audio signal is then compared (block 102) against a baseline ultrasonic audio signal for the device. Specifically, for a particular device, a database may include a variety of baseline ultrasonic audio signals that are representative of a device operating as expected. That is, the ultrasonic audio signals in the database may be generated by devices that operate as expected. This baseline ultrasonic signal may be generated based on machine learning. That is, the baseline ultrasonic signal may be generated based on collected data from a number of similar devices that are operating as expected. These collected signals are then combined, for example, averaged over various frequencies, to form the baseline ultrasonic audio signal.

As described above, a faulty, failing, or failed component may be identified as a deviation in the received ultrasonic audio signal from the baseline ultrasonic audio signal. Such deviations can be detected by comparing the received ultrasonic audio signal against this baseline ultrasonic audio signal. Accordingly, in comparing (block 102) the received ultrasonic audio signal and the baseline ultrasonic audio signal, deviations between the two are identified. The deviations may be deviations in frequency, amplitude, or combinations hereof. For example, a received ultrasonic audio signal may include spikes at certain frequencies that are not found in a baseline audio signal. In another example, the spikes may occur at certain expected frequencies, but may have amplitudes greater than expected.

Based on the any detected deviations, a failing component within the device can be identified (block 103). More specifically, if the deviation is greater than a threshold amount, a failing component is identified (block 103). A specific example of the identification of a failing component based on ultrasonic audio signal analysis is now provided. In this example, the device is a printing device and the faulty component is a faulty pick roller that moves media from an input tray into a printing path. In this example, an audio signal is received at an ultrasonic microphone, which audio signal is affected by the operation of the faulty pick roller component, which effect may include increases in amplitude of certain frequencies of the ultrasonic audio signal, and introduction of unexpected frequencies into the ultrasonic audio signal. This received ultrasonic audio signal is compared against a baseline ultrasonic audio signal, which baseline ultrasonic audio signal is indicative of a pick roller operating as expected. A comparison of the baseline ultrasonic audio signal and the received ultrasonic audio signal indicates a deviation between the two, and from this deviation, the faulty pick roller can be identified.

In some examples, identifying (block 103) the failing component includes executing a localization operation to identify the failing component. For example, the deviation between the received ultrasonic audio signal and the baseline ultrasonic audio signal may not allow for the specific identification of a component, but may allow for a general location of the failing component to be identified. Accordingly, a localization operation may allow the system to hone in on the failing component. For example, a general location of the failing component may be identified, in which general location there are multiple candidate failing components. The localization operation allows for the identification of the specific failing component from within the multiple candidate faulty components at the general location.

In this example, the localization operation can include iteratively operating various components, i.e., those from the multiple candidate failing components, to specifically identify the failing component. In some examples, this may be performed at a pre-determined time apart from identification of the candidate group of failing components. For example, the localization operation may be performed after business hours. In iteratively operating the various components, additional received ultrasonic audio signals can be compared to additional baseline ultrasonic audio signals to determine which of the candidate failing components is the source of the deviation. For example, a pick motor and a feed motor may be identified as candidate failing components. During the localization operation, the pick motor may be operated and a corresponding received ultrasonic audio signal for just the pick motor compared against a baseline ultrasonic audio signal for just the pick motor to determine if it is failing. Similarly, a feed motor may be operated by itself and a corresponding received ultrasonic audio signal for just the feed motor compared against a baseline ultrasonic audio signal for just the feed motor to determine if it is failing.

The localization operation may include analyzing at least one of 1) characteristics of the deviation and/or a timing of the deviation to identify the failing component. For example, the database of baseline ultrasonic audio signals may include information mapping a type of deviation to a particular failing component. That is, a failing pick roller may result in an audio signal having certain frequency and/or amplitude characteristics. A mapping between these certain frequency and/or amplitude characteristics and the failing pick roller can be stored in the database. Accordingly, when a received ultrasonic audio signal is determined to have these certain frequency and/or amplitude characteristics, the mapping may lead to the identification of the pick roller as the failing component.

Still further, the timing of the deviation may be used to identify the failing component. For example, if the deviation occurs at a point in time when the pick roller is not operating, it can be deducted that the pick roller is not the cause of the deviation in the ultrasonic audio signals.

Accordingly, as described herein, the method (100) offers a way to detect failing, failed, or faulty components before they would otherwise be detectable. More specifically, as components start to fail, the audio signal resulting from their operation begins to change. Using an ultrasonic microphone, components that are on the path of failing can be identified earlier, thus reducing their impact on printing operations. While specific reference is made to identifying faulty, failing, or failed components, the method (100) and system described herein may also be used to identify components that are out of specification, or that are incompatible with the device in which they are installed.

Moreover, the proposed method (100) and system ensure privacy. For example, microphones that capture signals in the audible range may also pickup conversations in the vicinity of the device, conversations that may be personal. The method (100) described herein addresses this potential complication by using ultrasonic microphones that are tuned to filter out audible audio signals.

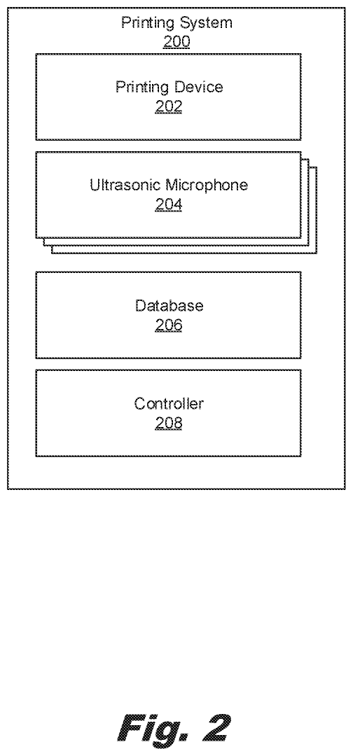

FIG. 2 is a block diagram of a printing system (200) for identifying a failing component using an ultrasonic microphone (204), according to an example of the principles described herein. The printing system (200) includes a printing device (202). The printing device (202) refers to a device that is used to eject fluid, such as a functional agent, ink or toner, onto a surface such as paper or a build material bed in an additive manufacturing apparatus. To eject the fluid, the printing device (202) includes a number of nozzles. As described above, the printing device (202) may be a two-dimensional printing device (202) that operates to deposit a printing fluid on a two-dimensional medium. In another example, the printing device (202) may be a three-dimensional printing device. In general, apparatuses for generating three-dimensional objects may be referred to as additive manufacturing apparatuses. The apparatus described herein may correspond to three-dimensional printing systems (200), which may also be referred to as three-dimensional printers.

In an example of an additive manufacturing process, a layer of build material may be formed in a build area. In the additive manufacturing process, any number of functional agents may be deposited on the layer of build material. One such example is a fusing agent that facilitates the hardening of the powder build material. In this specific example, the fusing agent may be selectively distributed on the layer of build material in a pattern of a layer of a three-dimensional object. An energy source may temporarily apply energy to the layer of build material. The energy can be absorbed selectively into patterned areas formed by the fusing agent and blank areas that have no fusing agent, which leads to the components to selectively fuse together. This process is then repeated until a complete physical object has been formed. Additional layers may be formed and the operations described above may be performed for each layer to thereby generate a three-dimensional object. Sequentially layering and fusing portions of layers of build material on top of previous layers may facilitate generation of the three-dimensional object. The layer-by-layer formation of a three-dimensional object may be referred to as a layer-wise additive manufacturing process.

The printing system (200) also includes at least one ultrasonic microphone (204). The ultrasonic microphones (204) may be disposed within the printing device (202) and positioned to capture ultrasonic audio signals. An ultrasonic microphone (204) may be any device that captures ultrasonic audio signals. In some examples, the ultrasonic microphones (204) are micro-electro-mechanical (MEMs) ultrasonic microphones (204).

In some examples, the printing system (200) includes a single ultrasonic microphone (204) that picks up the various audio signals throughout the printing device (202). In other examples, the printing system (200) includes multiple ultrasonic microphones (204). The different ultrasonic microphones (204) may be placed at different locations within the printing device (202) and/or may be tuned to different frequency ranges. For example, ultrasonic microphones (204) may be selected that are tuned to capture particular ranges of frequencies. The use of ultrasonic microphones (204) that are tuned to particular frequencies within the ultrasonic spectrum may provide additional detail and resolution that may allow for enhanced detection of failing components.

The system also includes a database (206) of baseline ultrasonic audio signals for the printing device (202). That is, the database (206) may include a repository of ultrasonic audio signals that are mapped to printing devices (202) that are operating as expected. In some cases, the database (206) may include audio signals that are component-specific. That is, the database (206) may include a general baseline audio signal for the printing device (202) as a whole. The database may also include component-specific baseline ultrasonic audio signals that reflect operation of just that specific component. These component-specific baseline ultrasonic audio signals can be used during localization operations to specifically identify a failing component from a group of candidate components.

The baseline ultrasonic audio signals within the database (206) may be grouped. For example, the baseline ultrasonic audio signals may be grouped by at least one of an age of the printing device (202) and/or a period of operation of the printing device (202). As a specific example, the database (206) may include one baseline audio signal for a new printing device (202) and another baseline ultrasonic audio signal for a 5-year old printing device (202).

Still further, the database (206) may include a baseline ultrasonic audio signal generated during a printing operation and may include another baseline ultrasonic audio signal generated during a copying operation. In another example, one baseline ultrasonic audio signal may correspond to a picking operation and another baseline ultrasonic audio signal may correspond to a post-processing operation.

The database (206) may also include mappings between particular deviations and identified failing components based on at least one of a timing of the detected deviation and characteristics of the detected deviation. For example, over time it may be identified that a particular frequency/amplitude signature is identified with a particular type of failure, or a particular failing component. The database (206) may include this mapping such that during a subsequent identification of a particular deviation, the particulars of that deviation may be analyzed, and the mapping in the database (206) consulted to particularly identify the failing component. Similarly, a timing of the deviation, i.e., during what period of operation the deviation occurs, is also mapped to types of failures and types of failing components.

The baseline ultrasonic audio signals within the database (206) may be dynamic. That means that over time, the baseline ultrasonic audio signals may be updated. For example, addition data, i.e., ultrasonic audio signals from similar devices, may be collected and the baseline ultrasonic audio signal updated. These updates may improve the accuracy of the baseline ultrasonic audio signal and may also be useful in detecting new failure modes that develop over time.

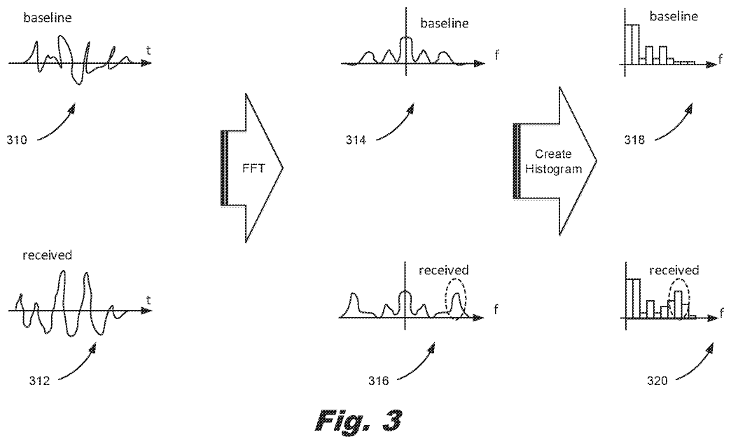

The system (200) also includes a controller (208). The controller (208) has various functions including comparing the received ultrasonic audio signal against the baseline ultrasonic audio signal for the printing device (202). As noted above, discrepancies between the two can indicate a potentially faulty, failing, failed, or out of spec component. As will be described below in FIG. 3 in some examples, this comparison includes processing a received ultrasonic audio signal in various ways.

Based on the detected deviations, the controller can identify a failing component within the printing device (202). Specifically, the controller (208) may first identify the general location of the failing component, and then initialize a localization operation to particularly identify the failing component. In another example, the controller (208) analyzes characteristics of the deviation such as a timing of the deviation, a frequency of the deviation, an amplitude of the deviation, among other characteristics. Knowing these characteristics, the controller (208) may access the database (206) to identify a mapping between the characteristics of the deviation and a previously identified mode of failure. Accordingly, the system (200) allows for the detection of ultrasonic audio signals that can be mapped to particular failing components. As the system incorporates ultrasonic microphones that are more sensitive than the human ear, i.e., they pick up audio signals before they are audible to the human ear, failing components can be identified earlier in the process. This early identification ensures repairs can be carried out before they halt, or otherwise affect, print operations. Moreover, using the database (206) and the controller (208), printing devices (202) operating as expected are mapped to audio signals such that the baseline audio signals can be used to identify particular failing components.

FIG. 3 is an illustration of a comparison between a received ultrasonic audio signal (312) and a baseline ultrasonic audio signal (310), according to an example of the principles described herein. In the example depicted in FIG. 3, the received ultrasonic audio signal (312) is abnormal suggesting there is a deviation from the baseline ultrasonic audio signal (310). The top portion of FIG. 3 depicts the conversion of a baseline ultrasonic audio signal (310) as it is received during the formation of the database (FIG. 2, 206). The bottom portion of FIG. 3 depicts the reception, and conversion of a received ultrasonic audio signal (312) as it is received from the ultrasonic microphone (FIG. 2, 204) during the operation of a device in which the ultrasonic microphone (FIG. 2, 204) is disposed.

Upon reception, an input to the ultrasonic microphone (FIG. 2, 204) may be amplified and time-sampled for a particular workflow to generate the received ultrasonic audio signal (312). As noted above, the database (FIG. 2, 206) may include baseline ultrasonic audio signals (310) that have been received, amplified, and time-sampled in a similar fashion such that they are comparable to the received ultrasonic audio signals (312).

The controller (FIG. 2, 208), or another device in the case of the baseline ultrasonic audio signal (310), may then perform an operation to convert the time-domain representations of the audio signals (310, 312) into frequency-domain representations of the signals (314, 316). Specifically, in assembling the database (FIG. 2, 206), the baseline ultrasonic audio signal (310) in the time domain can be converted, for example using a fast Fourier Transform (FFT) to generate a frequency domain baseline ultrasonic audio signal (314). Similarly, upon reception at an ultrasonic microphone (FIG. 2, 204) disposed within the printing device (FIG. 2, 202), the received ultrasonic audio signal (312) can be converted into a frequency-domain representation of the received ultrasonic audio signal (316). As depicted in FIG. 3, when in the frequency-domain a deviation between the baseline audio signal and the received audio signal are more readily discernible.

The controller (FIG. 2, 208), or other receiving device, may further process the frequency domain signals (314, 316) to generate histograms (318, 320) that plot the quantity of different frequencies within the respective audio signals. From these histograms (318, 320), the deviations between the baseline audio signal and the received audio signal can be readily identified. The database (FIG. 2, 206) may include a mapping of the histogram deviations to previously identified causes of failure. Using such a conversion allows for the simple processing of an ultrasonic audio signal such that it can be readily mapped to particular types of faulty or failing components. Moreover, this process facilitates the simple comparison of received ultrasonic audio signals to baseline ultrasonic audio signals in an effort to identify failing components.

Moreover, as described above, the database (FIG. 2, 206) may include numerous histograms (318, 320) that correspond to different characteristics of the operation of the associated device including a timing of the deviation, an age of the device, a period of operation of the device, etc.

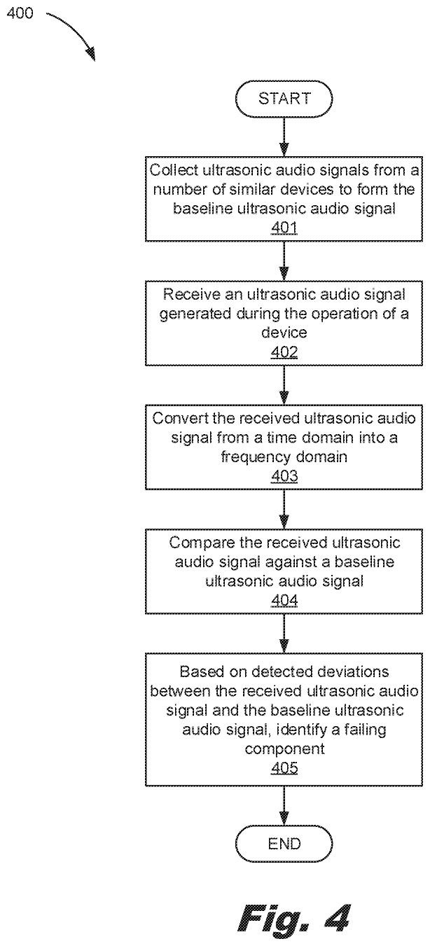

FIG. 4 is a flowchart of a method (400) for identifying a failing component using an ultrasonic microphone (FIG. 2, 204), according to an example of the principles described herein. According to the method (400), ultrasonic audio signals are collected (block 401) from a number of similar devices to form the baseline ultrasonic audio signal. Specifically, a number of devices, such as printing devices may be coupled to one another and to a central server via a network, such as the Internet. In this example, ultrasonic audio signals generated during the course of operation of these devices can be collected. These various ultrasonic audio signals can be combined to form the number of baseline ultrasonic audio signals described herein. For example, histograms as described above, from the various devices can be averaged to generate a general histogram. Moreover, this collected information could also be used to update the mappings between subsequently detected deviations and previously identified modes of failure.

The collection of ultrasonic audio signals may continue throughout the operation life of the printing device (FIG. 2, 202). That is, additional collected data can be added to the database (FIG. 2, 206) to refine the baseline ultrasonic audio signal. Doing so may account for new, and previously unidentified, component failures. Updates to the baseline ultrasonic audio signal can be passed to a particular device via the same network connection. In so doing, it can be ensured that an accurate baseline ultrasonic audio signal is always present on a particular device such that an accurate identification and determination of failing components is made.

The ultrasonic microphone (FIG. 2, 204) of the device then receives (block 402) an ultrasonic audio signal generated during the operation of a device. This may be performed as described above in connection with FIG. 1. The received ultrasonic audio signal is then converted (block 403) from a time domain representation, such as a .WAV file, into a frequency domain representation, such as a histogram (FIG. 3, 320) of the various frequencies within the ultrasonic audio signal. Such a conversion (block 403) presents the ultrasonic audio signal in a more analyzable format that facilitates a clear identification of deviations between the baseline ultrasonic audio signal and a received ultrasonic audio signal for the detection of deviations there between.

The frequency domain representation of received ultrasonic audio signal is then compared (block 404) against a frequency domain representation of the baseline ultrasonic audio signal. Specifically, the frequencies and amplitudes of the corresponding histograms (FIG. 3, 318, 320) can be compared and deviations detected. Examples of such deviations include deviations in the presence of unexpected frequencies, an unexpected quantity of expected frequencies or combinations thereof. Based on the detected deviations, a faulty component can then be identified (block 405). This may be performed as described above in connection with FIG. 1.

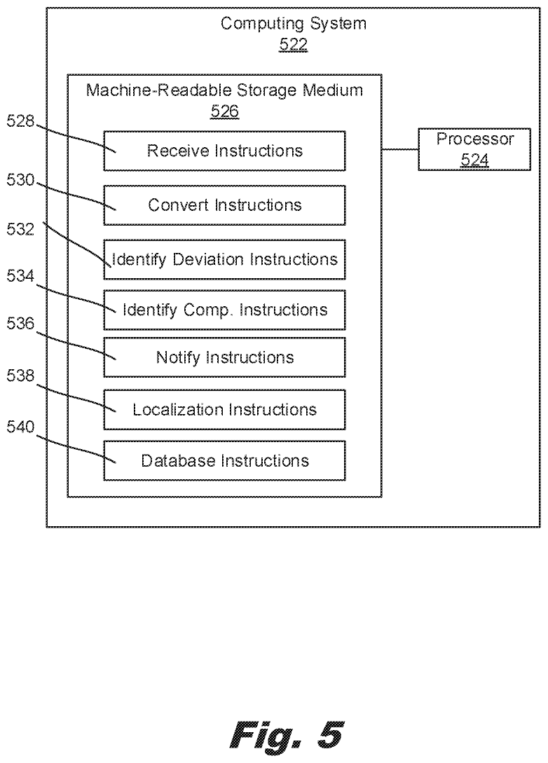

FIG. 5 is a diagram of a computing system (522) to identify a failing component using an ultrasonic microphone (FIG. 2, 204), according to an example of the principles described herein. To achieve its desired functionality, the computing system (522) includes various hardware components.

Specifically, the computing system (522) includes a processor (524) and a machine-readable storage medium (526). The machine-readable storage medium (526) is communicatively coupled to the processor (524). The machine-readable storage medium (526) includes a number of instruction sets (528, 530, 532, 534, 536, 538, 540) for performing a designated function. The machine-readable storage medium (526) causes the processor (524) to execute the designated function of the instruction sets (528, 530, 532, 534, 536, 538, 540).

Although the following descriptions refer to a single processor (524) and a single machine-readable storage medium (526), the descriptions may also apply to a computing system (522) with multiple processors and multiple machine-readable storage mediums. In such examples, the instruction sets (528, 530, 532, 534, 536, 538, 540) may be distributed (e.g., stored) across multiple machine-readable storage mediums and the instructions may be distributed (e.g., executed by) across multiple processors.

The processor (524) may include at least one processor and other resources used to process programmed instructions. For example, the processor (524) may be a number of central processing units (CPUs), microprocessors, and/or other hardware devices suitable for retrieval and execution of instructions stored in machine-readable storage medium (526). In the computing system (522) depicted in FIG. 5, the processor (524) may fetch, decode, and execute instructions (528, 530, 532, 534, 536, 538, 540) for detecting failing components in a device. In one example, the processor (524) may include a number of electronic circuits comprising a number of electronic components for performing the functionality of a number of the instructions in the machine-readable storage medium (526). With respect to the executable instruction, representations (e.g., boxes) described and shown herein, it should be understood that part or all of the executable instructions and/or electronic circuits included within one box may, in alternate examples, be included in a different box shown in the figures or in a different box not shown.

The machine-readable storage medium (526) represent generally any memory capable of storing data such as programmed instructions or data structures used by the computing system (522). The machine-readable storage medium (526) includes a machine-readable storage medium that contains machine-readable program code to cause tasks to be executed by the processor (524). The machine-readable storage medium (526) may be tangible and/or non-transitory storage medium. The machine-readable storage medium (526) may be any appropriate storage medium that is not a transmission storage medium. For example, the machine-readable storage medium (526) may be any electronic, magnetic, optical, or other physical storage device that stores executable instructions. Thus, machine-readable storage medium (526) may be, for example, Random Access Memory (RAM), a storage drive, an optical disc, and the like. The machine-readable storage medium (526) may be disposed within the computing system (522), as shown in FIG. 5. In this situation, the executable instructions may be “installed” on the computing system (522). In one example, the machine-readable storage medium (526) may be a portable, external or remote storage medium, for example, that allows the computing system (522) to download the instructions from the portable/external/remote storage medium. In this situation, the executable instructions may be part of an “installation package”. As described herein, the machine-readable storage medium (526) may be encoded with executable instructions for detecting a failing component in a device.

Referring to FIG. 5, receive instructions (528), when executed by a processor (524), may cause the computing system (522) to receive, at an ultrasonic microphone (FIG. 2, 204), an ultrasonic audio signal generated during the operation of a printing device (FIG. 2, 202). Convert instructions (530), when executed by a processor (524), may cause the computing system (522) to convert the received ultrasonic audio signal from a time domain representation into a frequency domain representation. Identify deviation instructions (532), when executed by a processor (524), may cause the computing system (522) to identify deviations between the frequency domain representation of the received ultrasonic audio signal and the frequency domain representation of the baseline ultrasonic audio signal. As described above, the deviations include deviations in amplitude, frequency, or combinations thereof. Identify component instructions (534), when executed by a processor (524), may cause the computing system (522) to, based on characteristics of the identified deviations being greater than a threshold amount, identify a faulty component within the printing device (FIG. 2, 202). Notify instructions (536), when executed by a processor (524), cause the computing system (522) to provide a notification of the faulty component within the printing device (FIG. 2, 202). Localization instructions (548), when executed by a processor (524), cause the computing system (522) to execute a localization operation to particularly identify a failing component. Database update instructions (550), when executed by a processor (524), cause the computing system to update a database of baseline ultrasonic audio signals based on field information received from similar devices over a network.

In some examples, the processor (524) and machine-readable storage medium (526) are located within the same physical component, such as a server, or a network component. The machine-readable storage medium (526) may be part of the physical component's main memory, caches, registers, non-volatile memory, or elsewhere in the physical component's memory hierarchy. In one example, the machine-readable storage medium (526) may be in communication with the processor (524) over a network. Thus, the computing system (522) may be implemented on a user device, on a server, on a collection of servers, or combinations thereof.

The computing system (522) of FIG. 5 may be part of a general-purpose computer. However, in some examples, the computing system (522) is part of an application specific integrated circuit.

In one example, using such a method 1) allows for early detection of failing, failed, or faulty components; 2) provides a detection method that does not rely on encryption of audio signals; and 3) is updateable based on collected operating information. However, it is contemplated that the devices disclosed herein may address other matters and deficiencies in a number of technical areas.

The preceding description has been presented to illustrate and describe examples of the principles described. This description is not intended to be exhaustive or to limit these principles to any precise form disclosed. Many modifications and variations are possible in light of the above teaching.

What is claimed is:

1. A method comprising:
receiving, at an ultrasonic microphone disposed in a device, an ultrasonic audio signal generated during an operation of the device;
comparing the received ultrasonic audio signal against a baseline ultrasonic audio signal for the device to detect deviations between the received ultrasonic audio signal and the baseline ultrasonic audio signal; and
based on detected deviations between the received ultrasonic audio signal and the baseline ultrasonic audio signal being greater than a threshold amount, identify a failing component within the device.

2. The method of claim 1:
further comprising converting the received ultrasonic audio signal from a time domain representation into a frequency domain representation; and
wherein comparing the received ultrasonic audio signal against the baseline ultrasonic audio signal comprises comparing frequencies and amplitudes found in the frequency domain representation of the received ultrasonic audio signal against frequencies and amplitudes found in the frequency domain representation of the baseline ultrasonic audio signal to detect deviations.

3. The method of claim 2, wherein the deviations comprise deviations in amplitude, deviations in frequency, or combinations thereof.

4. The method of claim 2, wherein the deviations comprise at least one of:
an unexpected frequency having an amplitude greater than a predetermined amount as compared against expected frequencies in the baseline ultrasonic audio signal; and
an unexpected amplitude of an expected frequency as found in the baseline ultrasonic audio signal.

5. The method of claim 1, further comprising collecting ultrasonic audio signals from a number of similar devices to form the baseline ultrasonic audio signal.

6. The method of claim 1, wherein identifying a failing component within the device comprises, upon detection of a deviation between the received ultrasonic audio signal and the baseline ultrasonic audio signal for the device being greater than a threshold amount, executing a localization operation to identify the failing component.

7. The method of claim 6, wherein the localization operation comprises at least one operation selected from the group consisting of:
iteratively operating various components of the printing device to identify the failing component; and
analyzing at least one of:
characteristics of the deviation; and
a timing of the deviation to identify the failing component.

8. A printing system comprising:
a printing device to form printed marks on a medium by depositing a printing compound on the medium;
at least one ultrasonic microphone, disposed within the printing device, to receive an ultrasonic audio signal generated during the operation of the printing device;
a database comprising a number of baseline ultrasonic audio signals for the printing device; and
a controller to:
compare the received ultrasonic audio signal against a baseline ultrasonic audio signal for the printing device; and
based on detected deviations between the received ultrasonic audio signal and the baseline ultrasonic audio signal for the printing device, identify a failing component within the printing device.

9. The printing system of claim 8, wherein the printing system comprises multiple ultrasonic microphones.

10. The printing system of claim 9, wherein the multiple ultrasonic microphones are positioned at different locations within the printing device.

11. The printing system of claim 9, wherein the multiple ultrasonic microphones are tuned to different frequencies within the ultrasonic spectrum.

12. The printing system of claim 8, wherein the database is indexed based on at least one of:
an age of the printing device; and
a period of operation of the printing device.

13. The printing system of claim 8, wherein the database identifies deviations based on at least one of:
a timing of the detected deviation; and
characteristics of the deviation.

14. A computing system comprising:
a processor;
a machine-readable storage medium coupled to the processor; and
an instruction set, the instruction set being stored in the machine-readable storage medium to be executed by the processor, wherein the instruction set comprises:
instructions to receive, at an ultrasonic microphone disposed in a printing device, an ultrasonic audio signal generated during the operation of the printing device;
instructions to convert the received ultrasonic audio signal from a time domain into a frequency domain;
instructions to compare a frequency domain representation of the received ultrasonic audio signal against a frequency domain representation of a baseline ultrasonic audio signal for the printing device; and
instructions to identify deviations between the frequency domain representation of the received ultrasonic audio signal and the frequency domain representation of the baseline ultrasonic audio signal, wherein the deviations comprises deviations in amplitude, frequency, or combinations thereof;
instructions to, based on characteristics of the identified deviations between the received ultrasonic audio signal and the baseline ultrasonic audio signal for the printing device being greater than a threshold amount, identify a faulty component within the printing device; and
instructions to, provide a notification of the failing component within the printing device.

15. The system of claim 14, wherein the instruction set further comprises instructions to update the baseline ultrasonic audio signal in the database.
